(19) United States
(12) Patent Application Publication
(10) Pub. No.: US 2011/0299296 A1
(43) Pub. Date: Dec. 8, 2011

(54) BACKLIGHT MODULE AND HEAT DISSIPATION MODULE

(75) Inventors: Hung-Chih Lin, Hsin-Chu (TW); Yi-Wen Lin, Hsin-Chu (TW)

(73) Assignee: YOUNG LIGHTING TECHNOLOGY CORPORATION, Hsin-Chu (TW)

(21) Appl. No.: 13/046,701

(22) Filed: Mar. 12, 2011

(30) Foreign Application Priority Data
Jun. 3, 2010 (TW) 99117960

(51) Int. Cl. F21V 7/22; F21V 29/00

(52) U.S. Cl. 362/606; 362/294

(57) ABSTRACT

A backlight module includes a back plate having a trench, a light guide plate disposed on the back plate, a reflecting sheet disposed between the back plate and the light guide plate, a heat dissipation module, and a light emitting element. The heat dissipation module includes a heat dissipation element, a heat conducting element, and a position-limiting element. The heat dissipation element is disposed on the back plate. The heat conducting element is disposed in the trench. One end of the heat conducting element is aligned with the heat dissipation element. The first position-limiting element is detachably assembled in the trench and supports the reflecting sheet. One section of the heat conducting element is pressed onto a bottom wall of the trench by the first position-limiting element. The light emitting element is disposed on the heat dissipation element and faces one side of the light guide plate.

### CROSS-REFERENCE TO RELATED APPLICATION

This application claims the priority benefit of Taiwan application Ser. No. 99117960, filed on Jun. 3, 2010. The entirety of the above-mentioned patent application is hereby incorporated by reference herein and made a part of this specification.

### BACKGROUND OF THE INVENTION

1. Field of the Invention

The invention relates to a heat dissipation module and a light source device applying this heat dissipation module, and more particularly, to a heat dissipation module and a backlight module applying this heat dissipation module.

2. Description of Related Art

Following the increasing advancement in the electronics industry, flat panel displays have gradually replaced cathode ray tube (CRT) displays and become the main stream in the market. Among various types of flat panel displays, a liquid crystal display is more mature and more popularized. However, a liquid crystal panel of the liquid crystal display does not emit light by itself. Therefore, a backlight module acting as a light source is disposed below the liquid crystal display panel to achieve the displaying function.

In a typical backlight module, a light emitting strip having a plurality of light emitting diodes is assembled to a back plate. The light emitting diodes, when emitting light, is cooled by the back plate. Specifically, the back plate may be provided with heat conducting elements with good heat conducting characteristic for transferring the heat of the light emitting diodes to the back plate. If the heat conducting element is mounted to the back plate by soldering or with adhesive, the fabrication process may be complex, and the rework or maintenance thereof may be difficult. In addition, if the reflecting sheet disposed on the back plate is not planar enough, the illumination uniformity of the backlight module may be degraded.

Some techniques relating to the heat conducting element of the backlight module are disclosed in U.S. Patent Application Publication No. U.S. 2006/0215420, Taiwan Patent No. TWM309684, and China Patent Application Publication No. CN101532626A. US Patent Application Publication No. U.S. 2006/0215420 discloses the structure shown in FIG. 1. In this structure, a heat pipe 41 is positioned to a back plate 34 by a metal strip 43. The metal strip 43 is fastened to the back plate 34 with screws 45.

### SUMMARY OF THE INVENTION

Accordingly, the invention is directed to a backlight module having a heat dissipation module, and the heat dissipation module of the backlight module may be reworked and maintained easily.

Other objects and advantages of the invention may be further illustrated by the technical features broadly embodied and described as follows.

In order to achieve one or a part of or all of the above advantages or other advantages, one embodiment of the invention provides a backlight module. The backlight module includes a back plate, a light guide plate, a reflecting sheet, a heat dissipation module, and a light emitting element. The back plate has a trench. The light guide plate is disposed on the back plate. The reflecting sheet is disposed between the back plate and the light guide plate. The heat dissipation module includes a heat dissipation element, a heat conducting element, and a first position-limiting element. The heat dissipation element is disposed on the back plate. The heat conducting element is at least partially disposed in the trench. One end of the heat conducting element is aligned with the heat dissipation element. The first position-limiting element is detachably assembled in the trench and supports the reflecting sheet. One section of the heat conducting element is pressed onto a bottom wall of the trench by the first position-limiting element. The light emitting element is disposed on the heat dissipation element and faces one side of the light guide plate.

In order to achieve one or a part of or all of the above advantages or other advantages, another embodiment of the invention provides a heat dissipation module. The heat dissipation module is adapted to be applied in a backlight module, wherein the backlight module includes a back plate, a light guide plate, a reflecting sheet, and a light emitting element, the back plate has a trench, the light guide plate is disposed on the back plate, and the reflecting sheet is disposed between the back plate and the light guide plate. The heat dissipation module includes a heat dissipation element, a heat conducting element, and a first position-limiting element. The heat dissipation element is disposed on the back plate. The light emitting element is disposed on the heat dissipation element and faces one side of the light guide plate. The heat conducting element is at least partially disposed in the trench. One end of the heat conducting element is aligned with the heat dissipation element. The first position-limiting element is detachably assembled in the trench and supports the reflecting sheet. One section of the heat conducting element is pressed onto a bottom wall of the trench by the first position-limiting element.

In summary, the embodiment or embodiments of the invention may have at least one of the following advantages. In the above embodiments of the invention, the first position-limiting element for positioning the heat conducting element on the back plate is detachably assembled to the back plate, and the rework and maintenance of the heat dissipation module may be facilitated. In addition, the first position-limiting element may be used to support the reflecting sheet other than the function of positioning the heat conducting element. Therefore, the reflecting sheet may be more planarly positioned on the back plate, and thus the illumination uniformity of the backlight module may be increased.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a partial cross-sectional view of a conventional backlight module.

FIG. 2 is an exploded view of a backlight module according to one embodiment of the invention.

FIG. 3 is a partial top view of the backlight module of FIG. 2.

FIG. 4 is a partial cross-sectional view of the backlight module of FIG. 3, taken along line I-I thereof.

FIG. 5 is a partial bottom view of the backlight module of FIG. 3.

FIG. 6 is a partial cross-sectional view of a backlight module according to another embodiment of the invention.

FIG. 7 is a partial cross-sectional view of a backlight module according to another embodiment of the invention.

FIG. 8 is a partial cross-sectional view of a backlight module according to another embodiment of the invention.

FIG. 9 is a partial cross-sectional view of a backlight module according to another embodiment of the invention.

FIG. 10 is a view showing a part of a heat dissipation module according to still another embodiment of the invention.

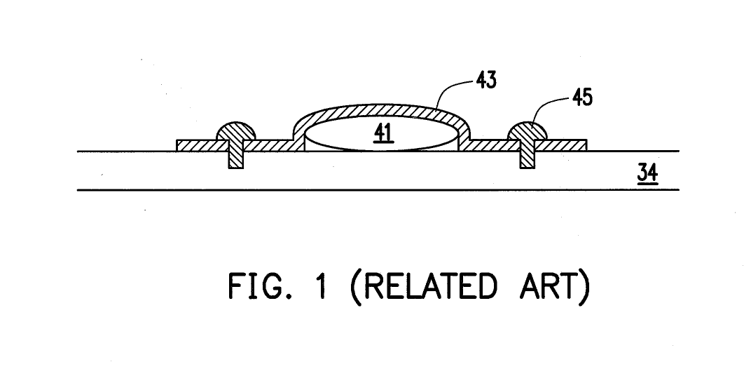

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purposes of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

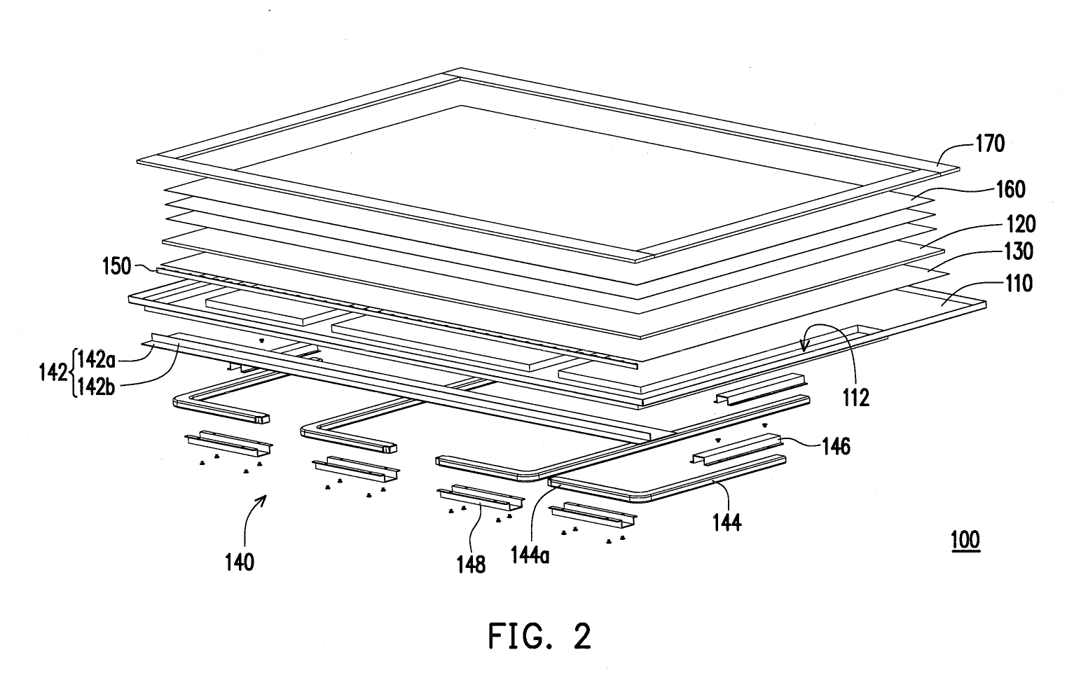

Referring to FIGS. 2 to 4, a backlight module 100 of the embodiment includes a back plate 110, a light guide plate 120, a reflecting sheet 130, a heat dissipation module 140, and a light emitting element 150. The back plate 110 has a trench 112 (multiple trenches 112 are shown). The light guide plate 120 is disposed on the back plate 110. The reflecting sheet 130 is disposed between the back plate 110 and the light guide plate 120.

The heat dissipation module 140 includes a heat dissipation element 142, a heat conducting element 144 (multiple heat conducting elements 144 are shown), and a first position-limiting element 146 (multiple position-limiting elements 146 are shown).

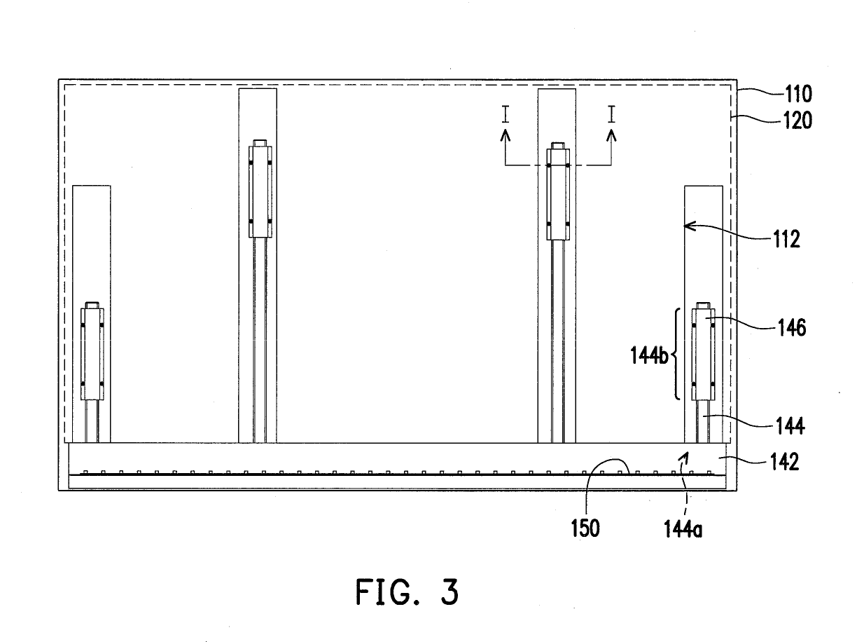

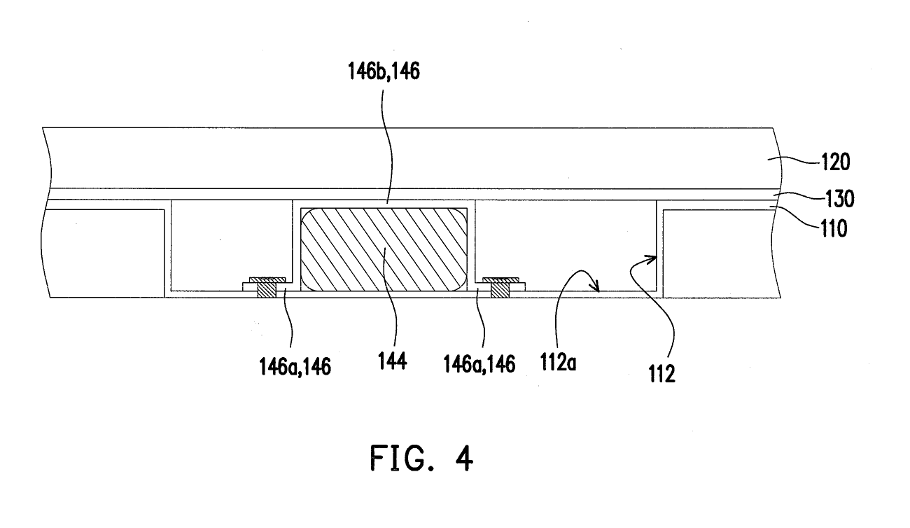

The light emitting element 150 of the embodiment is, for example, a light emitting strip having a plurality of light emitting diodes. The light emitting element 150 is disposed on the heat dissipation element 142 and faces a side of the light guide plate 120, such that light emitted by the light emitting element 150 may enter the light guide plate 120. The heat dissipation element 142 is disposed on the back plate 110. The material of the heat conducting element 144 of the embodiment is, for example, a metal material with high heat conducting efficiency. In another embodiment, the heat conducting element 144 may, for example, be a heat pipe. The heat conducting element 144 is disposed in the trench 112. One end 144a of the heat conducting element 144 is aligned with the heat dissipation element 142 to receive heat transferred from the light emitting element 150 to the heat dissipation element 142 and transfer the received heat to the back plate 110. The first position-limiting element 146 is detachably assembled in the trench 112 and supports the reflecting sheet 130. One section 144b (labelled in FIG. 3) of the heat conducting element 144 is pressed onto a bottom wall 112a (labelled in FIG. 4) of the trench 112 by the first position-limiting element 146.

In the embodiment, the first position-limiting element 146 for positioning the heat conducting element 144 on the back plate 110 is detachably assembled to the back plate 110. Therefore, both the first position-limiting element 146 and the heat conducting element 144 may be readily removed from the back plate 110, and thus the rework and maintenance of the heat dissipation module 140 may be facilitated. In addition to the function of positioning the heat conducting element 144, the first position-limiting element 146 may also be used to support the reflecting sheet 130. Thus, the downward deformation of the reflection sheet 130 at the area aligned with the trench 112 may be prevented. Therefore, the reflecting sheet 130 may be more planarly disposed on the back plate 110 to make illumination of the backlight module 100 more uniform.

Referring to FIG. 2, the backlight module 100 may further include optical sheets, e.g. a diffusion sheet 160 stacked on the light guide plate 120, and a frame 170 for supporting the overall structure. In addition, the heat dissipation element 142 includes a base 142a and an extension portion 142b. The base 142a lies down on the back plate 110. The extension portion 142b extends from the base 142a and is aligned with one side of the light guide plate 120. The light emitting element 150 is disposed on the extension portion 142b to face the side of the light guide plate 120.

Referring to FIG. 4, in the embodiment, the first position-limiting element 146 is, for example, fastened to the trench 112. However, this should not be regarded as limiting. In another embodiment, the first position-limiting element 146 may also be detachably assembled in the trench 112 in another suitable manner. Specifically, the first position-limiting element 146 includes two mounting portions 146a and a limiting portion 146b. The two mounting positions 146a are mounted on the bottom wall 112a of the trench 112. The limiting portion 146b is connected between the two mounting portions 146a and presses the section 144b (labelled in FIG. 3) of the heat conducting element 144 onto the bottom wall 112a.

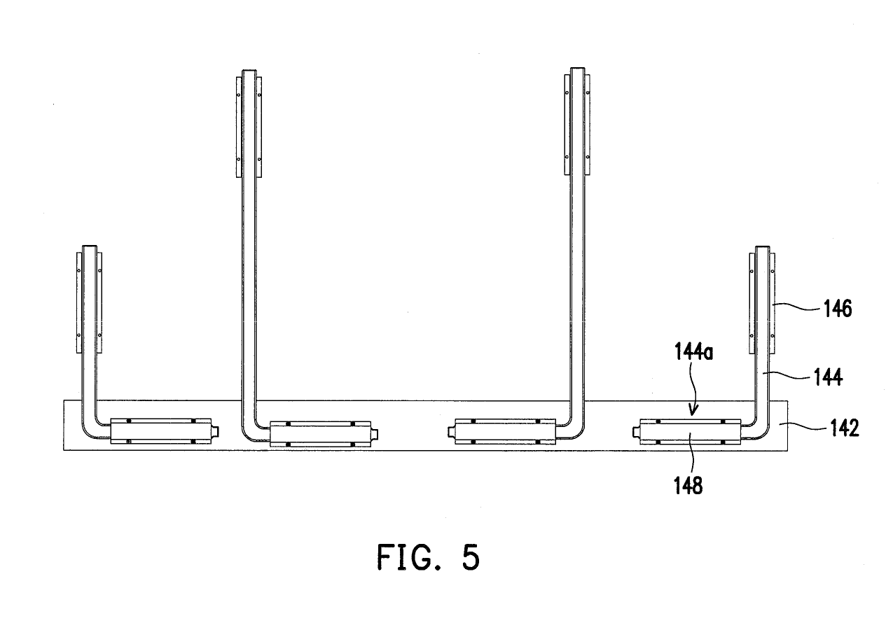

Referring to FIGS. 2 and 5, in the embodiment, the heat dissipation module 140 further includes a second position-limiting element 148 (multiple second position-limiting elements 148 are shown). The second position-limiting element 148 is detachably assembled to the heat dissipation element 142 and presses the end 144a of the heat conducting element 144 onto the heat dissipation element 142. However, the invention is not intended to limit the positioning of the end 144a of the heat conducting element 144 to any particular manner. The end 144a of the heat conducting element 144 may be positioned in other suitable manners as exemplified in alternative embodiments below.

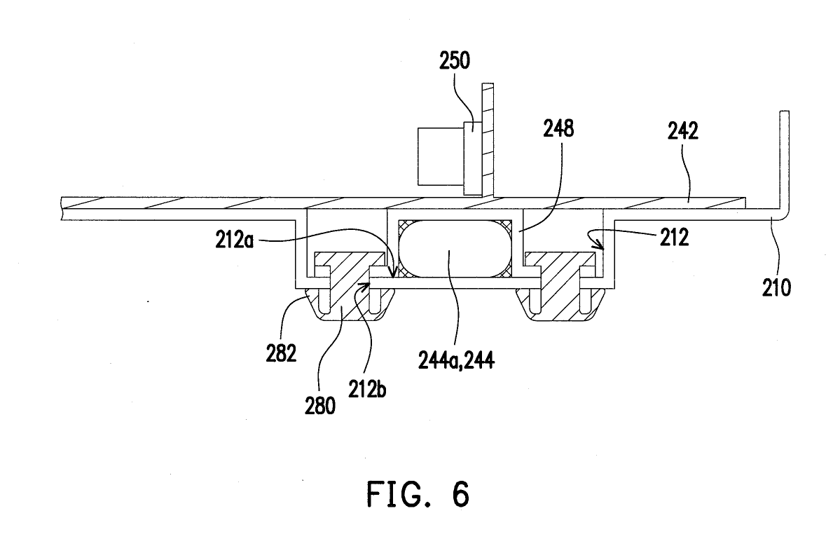

Referring to FIG. 6, in the embodiment, a second position-limiting element 248 is positioned in a trench 212 of a back plate 210 and supports a heat dissipation element 242 having light emitting elements 250. One end 244a of a heat conducting element 244 is pressed onto a bottom wall 212a of the trench 212 by the second position-limiting element 248. The second position-limiting element 248 of the embodiment is positioned in the trench 212 of the back plate 210, for example, by a mounting element 280. The mounting element 280 includes an elastic tab 282. Elastic deformation of the elastic tab 282 allows the mounting element 280 to easily pass through an assembly hole 212b for assembly. After finishing the assembly, the elastic tab 282 provides a position-limiting function to position the mounting element 280 at the position shown in FIG. 6.

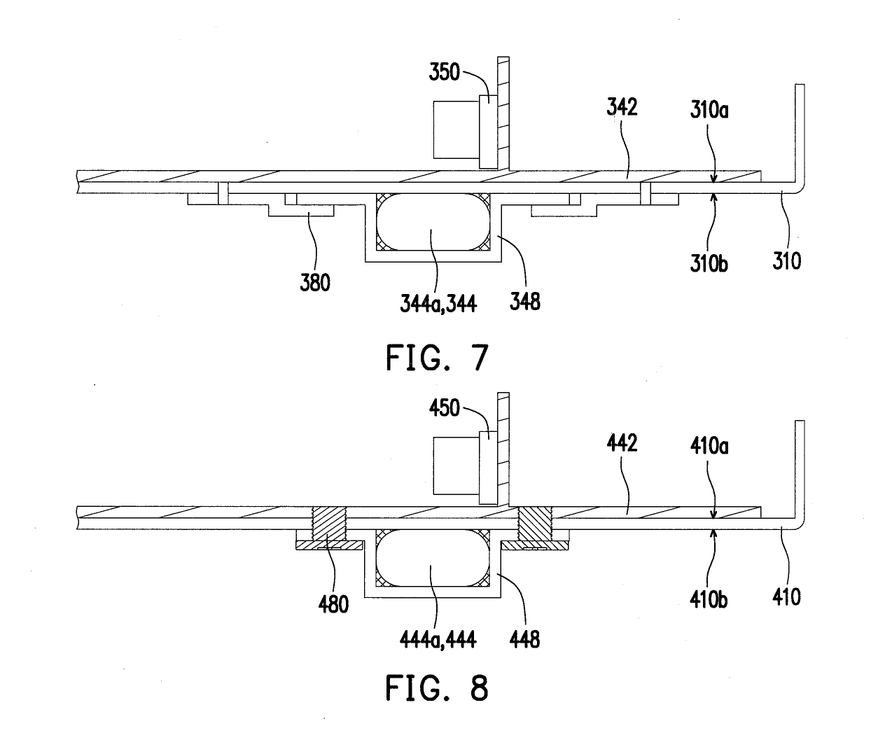

Referring to FIG. 7, in the embodiment, a back plate 310 does not include a trench corresponding to a heat dissipation element 342. The heat dissipation element 342 having light emitting elements 350 and a second position-limiting element 348 are positioned on a first surface 310a and a second surface 310b opposite to the first surface 310a of the back plate 310 respectively. One end 344a of a heat conducting element 344 is pressed onto a second surface 310b by the second position-limiting element 348.

The second position-limiting element 348 of the embodiment is positioned on the second surface 310b of the back plate 310 by, for example, a latching element 380.

Referring to FIG. 8, in the embodiment, a back plate 410 does not include a trench corresponding to a heat dissipation element 442. The heat dissipation element 442 having light emitting elements 450 and a second position-limiting element 448 are positioned on a first surface 410a and a second surface 410b opposite to the first surface 410a of the back plate 410 respectively. One end 444a of a heat conducting element 444 is pressed onto the second surface 410b by the second position-limiting element 448. The second position-limiting element 448 of the embodiment is positioned on the second surface 410b of the back plate 410 by, for example, a screw 480.

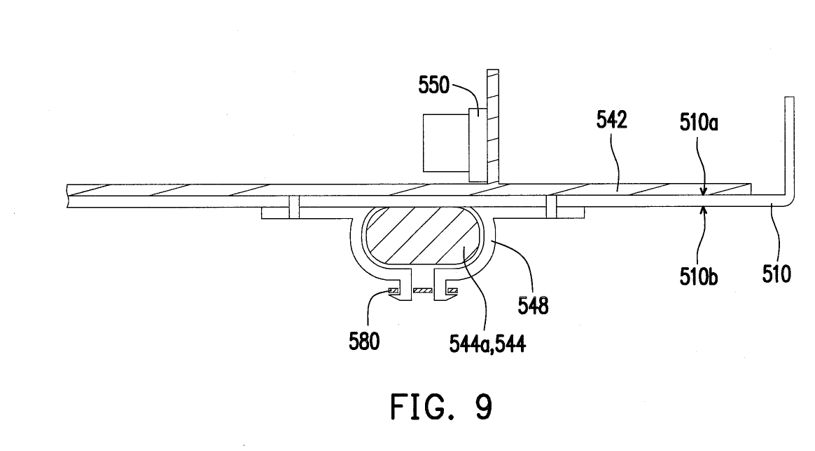

Referring to FIG. 9, in the embodiment, a back plate 510 does not include a trench corresponding to a heat dissipation element 542. The heat dissipation element 542 having light emitting elements 550 and a second position-limiting element 548 are positioned on a first surface 510a and a second surface 510b opposite to the first surface 510a of the back plate 510 respectively. One end 544a of a heat conducting element 544 is pressed onto the second surface 510b by the second position-limiting element 548. The second position-limiting element 548 of the embodiment is, for example, fastened by a fastener 580 so as to position the heat conducting element 544 at the position shown in FIG. 9.

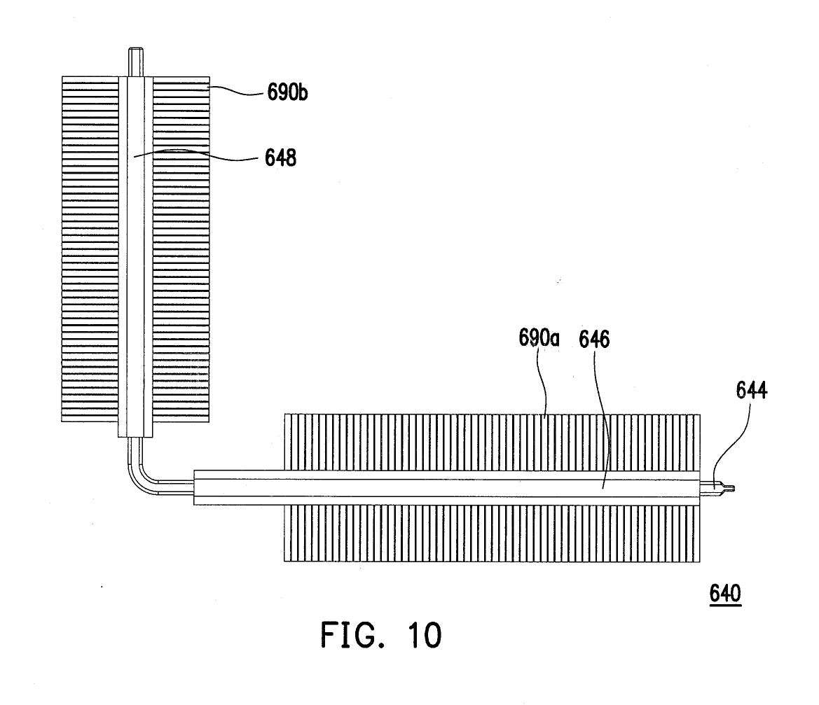

Besides, the all position-limiting elements in the above embodiments may be provided with heat dissipation fins to enhance heat dissipation efficiency, as exemplified below with reference to FIG. 10.

Referring to FIG. 10, a heat dissipation module 640 of the embodiment further includes a plurality of heat dissipation fins 690a and a plurality of heat dissipation fins 690b. The heat dissipation fins 690a and the heat dissipation fins 690b are connected to a first position-limiting element 646 and a second position-limiting element 648 respectively. Therefore, the heat dissipation area of the overall structure may be increased, such that a heat conducting element 644 may dissipate heat more efficiently.

Noticeably, this embodiment should not be regarded as limiting. Rather, in other embodiments, it is feasible that only the first position-limiting element 646 is provided with the heat dissipation fins 690a while the second position-limiting element 648 is not provided with the heat dissipation fins 690b, or only the second position-limiting element 648 is provided with the heat dissipation fins 690b while the first position-limiting element 646 is not provided with the heat dissipation fins 690a

In summary, the embodiment or embodiments of the invention may have at least one of the following advantages.

In the above embodiments of the invention, the first position-limiting element for positioning the heat conducting element on the back plate is detachably assembled to the back plate, and the rework and maintenance of the heat dissipation module may be facilitated. In addition, the first position-limiting element may be used to support the reflecting sheet other than the function of positioning the heat conducting element. Thus, the reflecting sheet may be more planarly positioned on the back plate to increase the illumination uniformity of the backlight module. Furthermore, the first position-limiting element and the second position-limiting element may further be provided with heat dissipation fins to further enhance the heat dissipation efficiency of the overall structure.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A backlight module comprising:
a back plate having a trench;
a light guide plate disposed on the back plate;
a reflecting sheet disposed between the back plate and the light guide plate;
a heat dissipation module comprising:
a heat dissipation element disposed on the back plate;
a heat conducting element at least partially disposed in the trench, wherein one end of the heat conducting element is aligned with the heat dissipation element; and
a first position-limiting element detachably assembled in the trench and supporting the reflecting sheet, wherein one section of the heat conducting element is pressed onto a bottom wall of the trench by the first position-limiting element; and
a light emitting element disposed on the heat dissipation element and facing one side of the light guide plate.

2. The backlight module according to claim 1, wherein the heat dissipation element comprises:
a base lying down on the back plate; and
an extension portion extending from the base and aligned with the side of the light guide plate, wherein the light emitting element is disposed on the extension portion.

3. The backlight module according to claim 1, wherein the first position-limiting element is fastened in the trench.

4. The backlight module according to claim 1, wherein the first position-limiting element comprises:
two mounting portions mounted on the bottom wall of the trench; and
a limiting portion connected between the two mounting portions and pressing the section of the heat conducting element onto the bottom wall.

5. The backlight module according to claim 1, wherein the heat dissipation module further comprises a plurality of heat dissipation fins connected to the first position-limiting element.

6. The backlight module according to claim 1, wherein the heat dissipation module further comprises a second position-limiting element, the second position-limiting element is detachably assembled to the back plate or the heat dissipation element, and the second position-limiting element limits the position of the end of the heat conducting element.

7. The backlight module according to claim 6, wherein the heat dissipation module further comprises a plurality of heat dissipation fins connected to the second position-limiting element.

8. The backlight module according to claim 6, wherein the second position-limiting element is mounted in the trench and supports the heat dissipation element, and the end of the heat dissipation element is pressed onto the bottom wall of the trench by the second position-limiting element.

9. The backlight module according to claim 6, wherein the heat dissipation element and the second position-limiting element are positioned on a first surface and a second surface opposite to the first surface of the back plate respectively, and the end of the heat conducting element is pressed onto the second surface by the second position-limiting element.

10. A heat dissipation module, adapted to be applied to a backlight module, wherein the backlight module comprises a back plate, a light guide plate, a reflecting sheet, and a light emitting element, the back plate comprises a trench, the light guide plate is disposed on the back plate, the reflecting sheet is disposed between the back plate and the light guide plate, the heat dissipation module comprising:
a heat dissipation element disposed on the back plate, wherein the light emitting element is disposed on the heat dissipation element and faces one side of the light guide plate;
a heat conducting element at least partially disposed in the trench, wherein one end of the heat conducting element is aligned with the heat dissipation element; and
a first position-limiting element detachably assembled in the trench and supporting the reflecting sheet, wherein one section of the heat conducting element is pressed onto a bottom wall of the trench by the first position-limiting element.

11. The heat dissipation module according to claim 10, wherein the heat dissipation element comprises:
a base lying down on the back plate; and
an extension portion extending from the base and aligned with the side of the light guide plate, wherein the light emitting element is disposed on the extension portion.

12. The heat dissipation module according to claim 10, wherein the first position-limiting element is fastened in the trench.

13. The heat dissipation module according to claim 10, wherein the first position-limiting element comprises:
two mounting portions mounted on the bottom wall of the trench; and
a limiting portion connected between the two mounting portions and pressing the section of the heat conducting element onto the bottom wall.

14. The heat dissipation module according to claim 10, further comprising a plurality of heat dissipation fins connected to the first position-limiting element.

15. The heat dissipation module according to claim 10, further comprising a second position-limiting element, wherein the second position-limiting element is detachably assembled to the back plate or the heat dissipation element, and the second position-limiting element limits the position of the end of the heat conducting element.

16. The heat dissipation module according to claim 15, further comprising a plurality of heat dissipation fins connected to the second position-limiting element.

17. The heat dissipation module according to claim 15, wherein the second position-limiting element is mounted in the trench and supports the heat dissipation element, and the end of the heat dissipation element is pressed onto the bottom wall of the trench by the second position-limiting element.

18. The heat dissipation module according to claim 15, wherein the heat dissipation element and the second position-limiting element are positioned on a first surface and a second surface opposite to the first surface of the back plate respectively, and the end of the heat conducting element is pressed onto the second surface by the second position-limiting element.
